(19) United States
(12) Patent Application Publication
(10) Pub. No.: US 2009/0024476 A1
(43) Pub. Date: Jan. 22, 2009

(54) METHOD AND SYSTEM FOR ENHANCED GEOGRAPHICALLY-BASED AND TIME-BASED ONLINE ADVERTISING

(75) Inventors: David J. P. Baar, Vancouver (CA); Andrew Carlisle, Vancouver (CA); Tiffany Chester, Vancouver (CA); Jamie Chong, Surrey (CA); Michael Doyle, Kelowna (CA); Keith Ippel, Richmond (CA); Zeenat Jetha, North Vancouver (CA); Robert Komar, Vancouver (CA); Catherine Montagnese, Calgary (CA); Chloe Morrow, Vancouver (CA)

Correspondence Address: McCarthy Tetrault LLP, Box 48, Suite #4700 Toronto Dominion Bank Tower, TORONTO, ON, M5K 1E6, CA

(73) Assignee: Idelix Software Inc., Vancouver (CA)

(21) Appl. No.: 12/175,512

(22) Filed: Jul. 18, 2008

Related U.S. Application Data
(60) Provisional application No. 60/950,391, filed on Jul. 18, 2007.

(51) Int. Cl. G06Q 30/00; G06K 9/34

(52) U.S. Cl. 705/14; 382/173

(57) ABSTRACT

A method for presenting advertisement images on a display screen, comprising: subdividing a map image into a plurality of geographic regions; associating a first advertisement image with a first region and a second advertisement image with a second region, the first and second regions being ones of the plurality of geographic regions; receiving a signal indicative of a region-of-interest, the region-of-interest being another of the plurality of geographic regions; selecting an advertisement image for the region-of-interest from among the first and second advertisement images; generating a presentation of the region-of-interest, the presentation including a view of the advertisement image; and, displaying the presentation on the display screen.

This application claims priority from U.S. Provisional Patent Application No. 60/950,391, filed Jul. 18, 2007, and incorporated herein by reference.

### FIELD OF THE INVENTION

This invention relates to the field of computer graphics processing and online advertising, and more specifically, to a method and system for generating and adjusting presentations for geographically-based and time-based online advertising applications.

### BACKGROUND OF THE INVENTION

The growth of the Internet and online map presentation technologies has resulted in broad availability of online and interactive presentations of maps and geographically relevant photographic images. Online geographic data presentations such as maps and images also present new opportunities for online advertising and for geographically-based advertising methods and systems. Some such methods and systems are described in U.S. patent application Ser. No. 11/593,047, which is incorporated herein by reference, in which presentation of particular advertisements is coupled to an expression of user interest in a specific geographic region, area, or location (e.g., a region-of-interest, area-of-interest, location-of-interest, etc.). However, for example, such methods and systems to do not fully address situations where locations-of-interest have already been established or where a user's location is to be taken into account.

A need therefore exists for an improved method and system for generating and adjusting presentations for geographically-based and time-based online advertising applications. Accordingly, a solution that addresses, at least in part, the above and other shortcomings is desired.

### SUMMARY OF THE INVENTION

According to one aspect of the invention, there is provided a method for presenting advertisement images on a display screen, comprising: subdividing a map image into a plurality of geographic regions; associating a first advertisement image with a first region and a second advertisement image with a second region, the first and second regions being ones of the plurality of geographic regions; receiving a signal indicative of a region-of-interest, the region-of-interest being another of the plurality of geographic regions; selecting an advertisement image for the region-of-interest from among the first and second advertisement images; generating a presentation of the region-of-interest, the presentation including a view of the advertisement image; and, displaying the presentation on the display screen.

According to another aspect of the invention, there is provided a method for presenting advertisement images on a display screen, comprising: subdividing a map image into a plurality of geographic regions; associating first and second advertisement images with a region within the plurality of geographic regions, the first advertisement image being associated with a first category of advertisement images and the second advertisement image being associated with a second category of advertisement images; receiving a signal indicative of a region-of-interest, the region-of-interest corresponding to the region; selecting an advertisement image for the region-of-interest from among the first and second advertisement images; generating a presentation of the region-of-interest, the presentation including a view of the advertisement image; and, displaying the presentation on the display screen.

According to another aspect of the invention, there is provided a method for presenting advertisement images on a display screen, comprising: subdividing a map image into a plurality of geographic regions; associating an advertisement image with a location within a region of the plurality of geographic regions; receiving a signal indicative of a region-of-interest, the region-of-interest corresponding to the region; generating a presentation of the region-of-interest, the presentation including the advertisement image; and, displaying the presentation on the display screen.

According to another aspect of the invention, there is provided a method for presenting advertisement images on a display screen, comprising: subdividing a map image into a plurality of geographic regions; receiving a signal indicative of a first region of the plurality of geographic regions; sending a signal indicative of the first region to a server, the server associating a first advertisement image with the first region; receiving the first advertisement image from the server; generating a first presentation of the first region, the first presentation including the first advertisement image; and, displaying the first presentation on the display screen.

In accordance with further aspects of the present invention there is provided an apparatus such as a data processing system, a method for adapting this system, as well as articles of manufacture such as a computer readable medium having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a data processing system adapted for implementing an embodiment of the invention;

FIG. 2 is a partial screen capture illustrating an online map and advertisement presentation in accordance with an embodiment of the invention;

FIG. 3 is a screen capture illustrating a first advertisement presentation in accordance with an embodiment of the invention;

FIG. 4 is a screen capture illustrating a second advertisement presentation in accordance with an embodiment of the invention;

FIG. 5 is a screen capture illustrating a third advertisement presentation in accordance with an embodiment of the invention;

FIG. 6 is a screen capture illustrating a fourth advertisement presentation in accordance with an embodiment of the invention;

FIG. 7 is a screen capture illustrating a fifth advertisement presentation in accordance with an embodiment of the invention;

FIG. 8 is a screen capture illustrating a sixth advertisement presentation in accordance with an embodiment of the invention;

FIGS. 9-12 are screen captures illustrating seventh through tenth advertisement presentations in accordance with embodiments of the invention;

FIG. 13 is a partial screen capture illustrating a graphical user interface having lens control elements for adjusting detail-in-context presentations in accordance with an embodiment of the invention; and,

FIG. 14 is a flow chart illustrating operations of modules within a data processing system for presenting advertisement images on a display screen, in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and methods have not been described or shown in detail in order not to obscure the invention. The term “data processing system” is used herein to refer to any machine for processing data, including the computer systems and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The present invention may also be implemented in hardware.

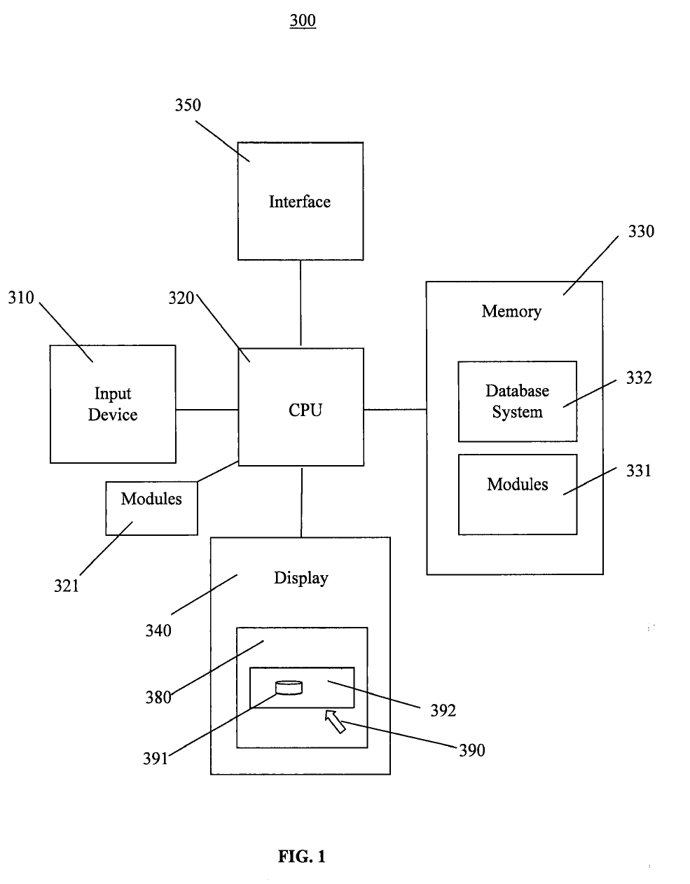

FIG. 1 is a block diagram illustrating a data processing system 300 adapted to implement an embodiment of the invention. The data processing system 300 is suitable for generating, displaying, and adjusting presentations in conjunction with a graphical user interface (“GUI”), as described below. The data processing system 300 may be a client and/or server in a client/server system. For example, the data processing system 300 may be a server system or a personal computer (“PC”) system. The data processing system 300 may also be a wireless device or other portable or handheld device. The data processing system 300 includes an input device 310, a central processing unit (“CPU”) 320, memory 330, a display 340, and an interface device 350. The input device 310 may include a keyboard, a mouse, a trackball, a touch sensitive surface or screen, a position tracking device, an eye tracking device, or a similar device. The display 340 may include a computer screen, television screen, display screen, terminal device, a touch sensitive display surface or screen, or a hardcopy producing output device such as a printer or plotter. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (not shown) over a network (not shown) via the interface device 350. For example, the interface device 350 may include an interface to a network such as the Internet and/or another wired or wireless network. Thus, the data processing system 300 may be linked to other data processing systems by the network. The CPU 320 may include or be operatively coupled to dedicated coprocessors, memory devices, or other hardware modules 321. The CPU 320 is operatively coupled to the memory 330 which stores an operating system (not shown) for general management of the system 300. The CPU 320 is operatively coupled to the input device 310 for receiving user commands or queries and for displaying the results of these commands or queries to the user on the display 340. Commands and queries may also be received via the interface device 350 and results may be transmitted via the interface device 350. The data processing system 300 may include a database system 332 for storing data and programming information. The database system 332 may include a database management system and a database and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium (e.g., a compact disk (“CD”), a floppy disk, etc.) which may be used for transporting the programmed instructions to the memory 330 of the data processing system 300. Alternatively, the programmed instructions may be embedded in a computer-readable signal or signal-bearing medium that is uploaded to a network by a vendor or supplier of the programmed instructions, and this signal or signal-bearing medium may be downloaded through an interface (e.g., 350) to the data processing system 300 from the network by end users or potential buyers.

A user may interact with the data processing system 300 and its hardware and software modules 321, 331 using a graphical user interface (“GUI”) 380. The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

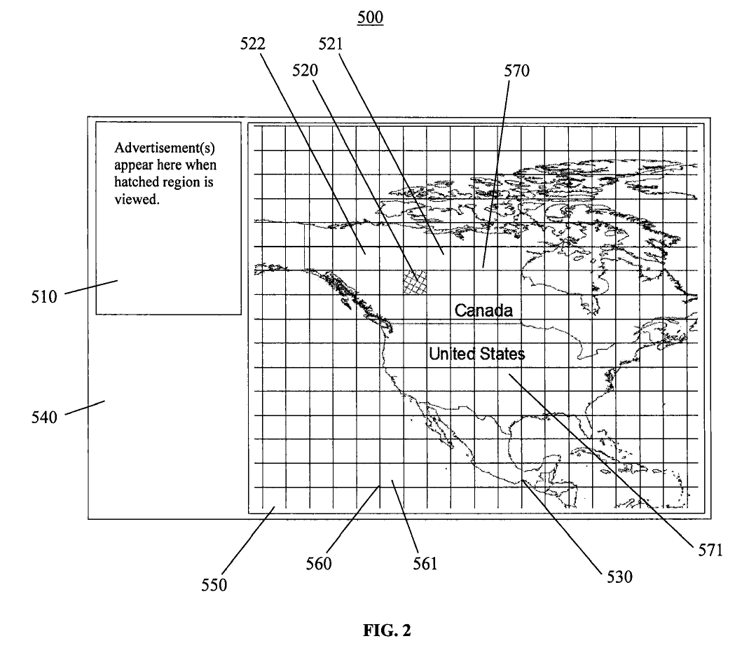

Geographically-Based and Time-Based Online Advertising. FIG. 2 is a partial screen capture illustrating an online map and advertisement presentation 500 in accordance with an embodiment of the invention. In FIG. 2, an advertiser pays to have an advertisement 510 (or advertisements 510) appear when a user later views a region or area 520 (shown as hatched in FIG. 2) on a map 530. According to one embodiment, prior to the user seeing this presentation 500, persons or corporations (i.e., advertisers) wishing to purchase space for advertisement presentation purchase from an advertising host or vendor the right or service of having a specific advertisement 510 appear when a given geographic region (i.e., a region-of-interest) or area 520 on a map 530 is later viewed, either in whole or in part, by a user on the user's display screen 340. Then, when the user later views the area or region 520, the advertisement 510 is presented in the presentation 500. According to one embodiment, the advertisement 510 may appear in a separate advertisement view or window 540 as shown in FIG. 2. According to another embodiment, the advertisement 510 may be presented using a window, overlay, or transparency (not shown) over the map 530 in the map view or window 550. According to another embodiment, other means of advertisement presentation may be used.

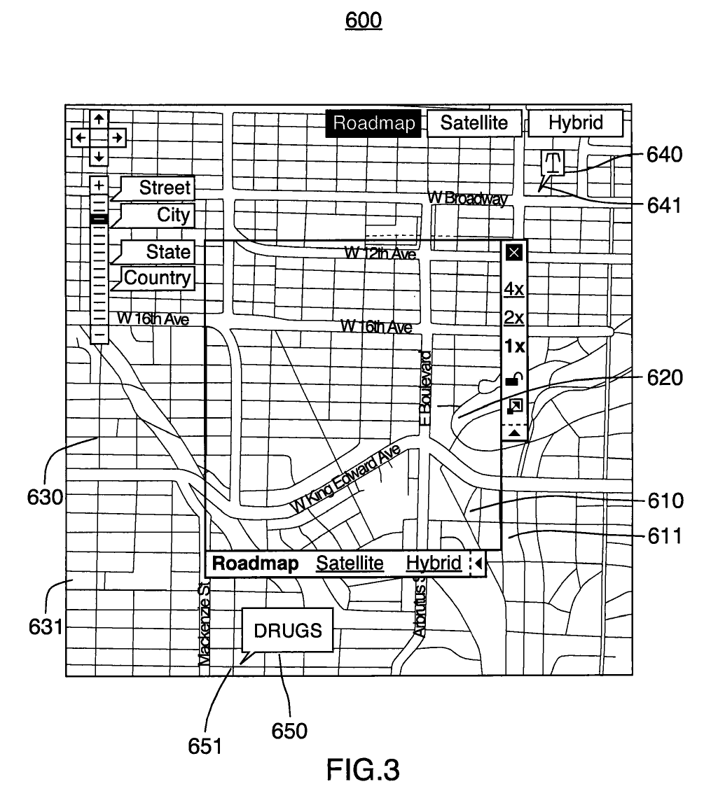

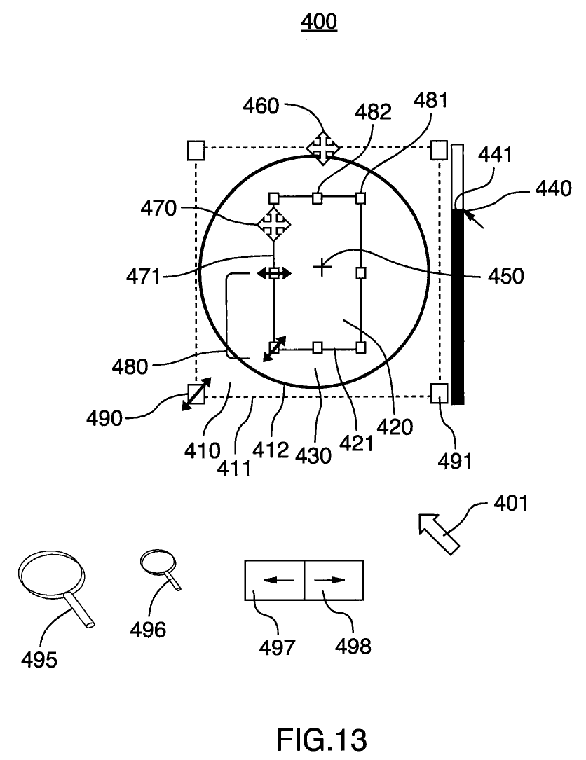

According to one embodiment, the user is provided with the ability to view the map 530 using an inset magnifier (610 in FIG. 3) or a detail-in-context lens (410 in FIG. 13) both as described below. In this embodiment, the advertisement 510 may be presented when the user moves the magnifier or lens over any part of the specified area or region 520. According to one embodiment, the advertisement 510 may be presented in a separate viewing area, view, or window 540 adjacent to the map 530. According to another embodiment, the advertisement 510 may be presented adjacent to, or overlaid on, the inset magnifier 610 or lens 410 in the map view or window 550.

According to one embodiment, an advertising vendor or host may sell advertising services (e.g., 510) to one or more advertisers for one or more geographic areas or regions (e.g., 520). In this embodiment, a map such as a world map or country map (e.g., 530) may be subdivided into a grid 560 and advertising services may be sold for presenting advertisements (e.g., 510) with respect to each unit 561 of the grid 560. According to another embodiment, the advertising vendor may sell advertising services on the basis of coverage of a specific (or predetermined) geographic area such as a city, state, province, or country (e.g., Canada 570, the United States 571, etc.). According to another embodiment, the advertising services offered for sale may be sold on a temporal as well as a geographic basis. For example, an advertiser may purchase from the advertising vendor an advertising service providing for the display of a particular advertisement (e.g., 510) for a particular period of time (e.g., a prime Internet usage period, a weekday, a month, etc.). The advertising services would pertain to a particular geographic area or region (e.g., 520, 561, 570, 571) and appropriate advertisements (e.g., 510) would be presented when a user (i.e., a customer of the advertiser) views the particular geographic area or region (i.e., a region-of-interest to the user). When the user views the particular geographic area or region, the advertisement(s) 510 may be presented to the user either in a main map view or window 550, advertisement view or window 540, or when the extent of an inset magnifier or a detail-in-context lens presented to the user on the user's display screen 340 intersects (or is positioned over) that area or region 520, 561, 570, 571.

One of the business considerations with respect to the above is the pricing to be charged for the presentation of advertisements 510 associated with a particular area 520. For example, one would expect that a particular geographic region such as a major city or country (e.g., the United States 571) would have more frequent user traffic and hence would be of more value to advertisers than a remote region such as Antarctica. As such, according to one embodiment, advertising services may be sold on a per-view basis. According to another embodiment, advertising services may be sold through an auction process in which the right to have an advertisement appear when the user views a particular region is won by the highest bidder for that region. In this case, a per view price may also be charged after the right to present an advertisement is purchased via auction.

According to one embodiment, the displayed advertisement image 510 may change with scale. That is, if the scale of the map image 530 changes or is adjusted, a different advertisement image 510 may be presented (i.e., one with different content), with rights to regions at specific presentation scales having previously been sold to advertisers.

Thus, embodiments of the present invention, as described above, may be considered as methods for the sale of “virtual real estate” for advertising purposes, wherein the real estate of the globe (or a given portion of the globe) is subdivided (e.g., 560) and sold based on the presentation of specific advertisements (e.g., 510) when a predetermined geographic region (e.g., 520, 561) is viewed by a user in whole or in part in a main map view or window 550, or in an inset magnifier, or in a detail-in-context lens.

As mentioned above, the growth of the Internet and online map presentation technologies has resulted in broad availability of online and interactive presentation of maps and geographically relevant photographic images. Online geographic data presentations such as maps and images also present new opportunities for online advertising and for geographically-based advertising methods and systems. The present invention provides an improved method for the presentation of online advertisements. The method addresses, among other things, situations where locations-of-interest have already been established and where a user's location is to be taken into account. The method includes the improvements and enhancements described in the following.

Advertisement Selection. In a tile-based or other region-based or location-based advertising method or system such as that described above with respect to FIGS. 1-2, it may occur, especially during the initial sale of regions 520, 521, 522 for advertising purposes, that some regions (e.g., 522) remain unsold or “vacant”. In addition, the site (e.g., Web site) displaying advertisements (e.g., 510) may wish to display more than one advertisement. Thus, a method for selecting which advertisement(s) or additional advertisement(s) is to be displayed is required. In addition, it may be determined that the advertisement (e.g., 510) associated with the present region-of-interest (e.g., 520) is inappropriate for presentation to the user. For example, the advertisement 510 may be for competing goods or services to those offered by the advertisement publishing site (e.g., Web site), the advertisement 510 may be unsuitable for the user due to the user's age or other established demographic information pertaining to the user, etc. To address these situations, embodiments of the present information described below are provided for the selection of alternate or additional advertisements 510.

According to a first embodiment, an advertisement (e.g., 510) from or associated with an adjacent or nearby purchased region 520 may be presented for the vacant region 522. Where there is a plurality of adjacent or nearby regions 520, 521, this embodiment may employ a method of advertisement selection that takes into account one or more of the following:
a) Distance from the immediate region of interest 522 to the purchased regions 520, 521.
b) Distance from an established or approximated location of the user to the purchased regions 520, 521. The location of the user may be established from Internet protocol (“IP”) address, coordinates supplied from a global positioning system (“GPS”) receiver or other locating system, or by other means.
c) Any subject or category of interest, whether expressed by the user explicitly or established by other means including the user's browsing history.
d) An advertising price or additional premium price paid by an advertiser for the right for an advertisement (e.g., 510) to be presented for regions (e.g., 522) other than the purchased region (e.g., 520). In this case, the precedence of selection for presentation of one advertisement over another may be further determined according to the price paid by advertisers for this additional advertisement presentation.
e) Distance from roads, landmarks, or other proximal geographic features to the purchased regions 520, 521.
f) A fixed or random offset vector which may be applied to the current region-of-interest location 522 to cause an advertisement (e.g., 510) from another region 520, 521 to be selected.

According to a second embodiment, in the case where regions 520, 521, 522 for advertisements may be purchased based on scale as well as region-of-interest, an alternative or additional advertisement (e.g., 510) may be selected for presentation for the vacant region 522 from among the advertisements for regions 520, 521 sold at other scales. In this case, similar methods for advertisement selection to those described above for the first embodiment may be applied.

According to a third embodiment, a default advertisement (e.g., 510) may be presented for the vacant region 522. In this embodiment, the right for the default advertisement to be presented may be sold to another advertiser. In addition, such default advertisement presentation rights may be sold for specific regions (e.g., 522) and scales.

Remote and Client-Server Advertisement Presentation. According to one embodiment, an improved geographically-based advertising method is provided which includes the separation of the advertising purchasing and selection implementation functions from the advertising presentation site (e.g., Web site). This embodiment includes the following features and potential advantages.

First, an “advertising engine” (or module 331 or system 300) may be provided from which multiple advertising publisher sites (e.g., Web sites) could request advertisements 510 from the remotely located advertising engine based on specifying location (e.g., by latitude and longitude, etc.) and/or scale. Alternately, the scale could be assumed by the engine. For example, a scale showing street level information may be used if the user is known to be using a mobile device. In this case, it is not essential for a map 530 to be presented to the user to use the advertising engine. Rather, knowledge of user location or location-of-interest may be sufficient to determine which advertisement 510 should be presented. This embodiment may be particularly applicable to advertising on compact devices such as mobile phones and personal navigation devices.

Second, regions 520, 521, 522 for advertising may be sold on one or more Web sites coupled to the advertising engine as a means to populate the advertising engine with advertisements 510.

Third, the advertising engine may be populated with advertisements 510 from an existing external advertisement database (e.g., 332). For example, this feature may be implemented using known geographic coordinate information within the external advertising database. Or, this feature may be implemented by geo-coding of address information from the external advertising database into geographic coordinates. This feature may be particularly applicable during the initial use of the advertising engine when the engine itself may be sparsely populated with advertisements 510.

Fourth, in the case where the advertising publisher Web site is distinct from the advertising engine, such as at a distinct node (e.g., 300) on a network, it may be important to minimize client requests to the server for advertisements 510, or to otherwise expedite the presentation of advertisements to the user. According to one embodiment, this may be accomplished by the following methods:
a) Supporting asynchronous advertisement requests to the server (e.g., 300 configured as a server) from the client (e.g., 300 configured as a client) and advertisement caching on the client. This may be performed by initially communicating the region-of-interest 520 or map extents 530 to the server from the client and then retrieving a plurality of advertisements 510 appropriate to the region-of-interest 520 and nearby regions 521, 522 from the server for later display on the client without another request to the server, when, for example, the region-of-interest changes.
b) Rather than request an advertisement 510 from the server upon each change in cursor 390 location on the client, or upon each change in user location change or region-of-interest change, requests from client to server may be performed as follows: when the cursor 390 or region-of-interest 520 has changed by a specific distance in screen coordinates or geospatial coordinates; when a specific boundary has been crossed such as a boundary 570, 571 in a grid 560; or, when a specific time interval has elapsed after which new advertisement requests may be made.

Multiple Advertising Categories. According to one embodiment, an improved geographically-based advertising method is provided which includes the sale and presentation of advertisements 510 using a plurality of advertising categories.

According to one embodiment, only advertisements from businesses in a specific category may be presented. This may be based on the following: a selection of a category by the advertising publisher; an expression of interest by the user in a particular type of business or subject matter of interest (e.g., restaurants, electronics vendors, etc.); or, any established characteristic of the user (e.g., prior browsing history within the subject of interest, etc.). In this way, multiple advertisements 510 may be sold for a given region 520 for each of the business categories. This embodiment may be considered as providing multiple “virtual worlds” in which each virtual world represents a particular category of business or subject matter (e.g., news, sports, technology, etc.).

According to another embodiment, the set of advertisements 510 to be presented may be extracted from a plurality of categories. In this embodiment, the advertisements 510 to be presented are filtered, the filtering criteria including business categories. The exact filters to be employed may depend on a selection by the user or may be pre-determined by the advertising publisher. In addition, a search using a search engine may be used to determine likely subjects of interest for the user.

Geographically-Coupled Advertising Presentation. FIG. 3 is a screen capture illustrating a first advertisement presentation 600 in accordance with an embodiment of the invention. As described above and shown in FIGS. 1-2, advertisers are provided with the option to buy regions or map tiles 520, 521, 522 based on the geo-coordinates of a company location, business location, or other location. In addition, advertisers are provided with the option of presenting one or more pushpins 640, 650 or other graphical indicators on a map 630 at locations 641, 651 of businesses belonging to or associated with the advertiser. FIG. 3 shows geo-located advertisements 640, 650 for the case of a single business location 641, 651 for each of two advertisers. In this embodiment, first and second advertisements 640, 650 appear in a peripheral area 631 of the map 630 (i.e., outside of an inset magnifier 610 presented for the map 630) and the locations 641, 651 are based on their actual geo-coordinates.

Also shown in FIG. 3 is an inset magnifier 610 in accordance with an embodiment of the invention. The inset magnifier 610 is applied to a region-of-interest 620 in the map 630. The inset magnifier 610 has an associated graphical user interface 611 for adjusting the magnification (e.g., “1×”, “2×”, “4×”, etc.), extent, content (e.g., roadmap image, satellite image, hybrid image, etc.), etc., of the inset magnifier 610. In FIG. 3, a magnification level of “1×” (i.e., no magnification) has been applied to the region-of-interest 620 by the inset magnifier 610.

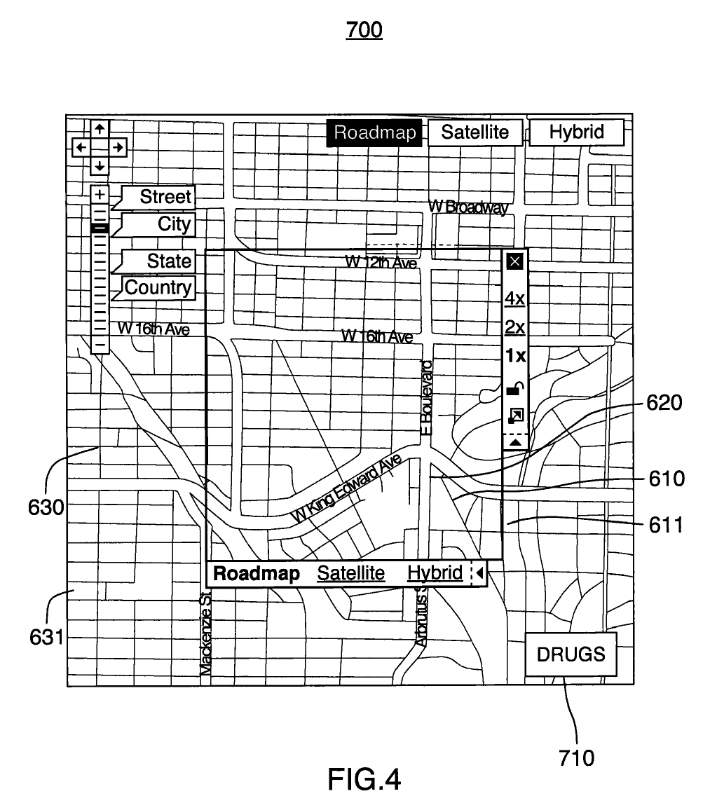

FIG. 4 is a screen capture illustrating a second advertisement presentation 700 in accordance with an embodiment of the invention. The presentation 700 of FIG. 4 is based on a geographical advertising system where tiles or regions 520, 521, 522 can be purchased regardless of the advertiser's actual geo-coordinates. In FIG. 4, advertisements 710 appear on the bottom right corner of the map 630 and additional presentation options are provided for the advertiser. In this embodiment, the user may have no knowledge before seeing the advertisement 710 of where the advertiser's business is located. FIG. 4 shows one advertisement 710. This advertisement 710 may appear with a dropdown menu that allows the user to:

a) Show all business locations of the advertiser.

b) Find one near the user.

c) Go to a Web site.

d) Get directions to a business location of the advertiser.

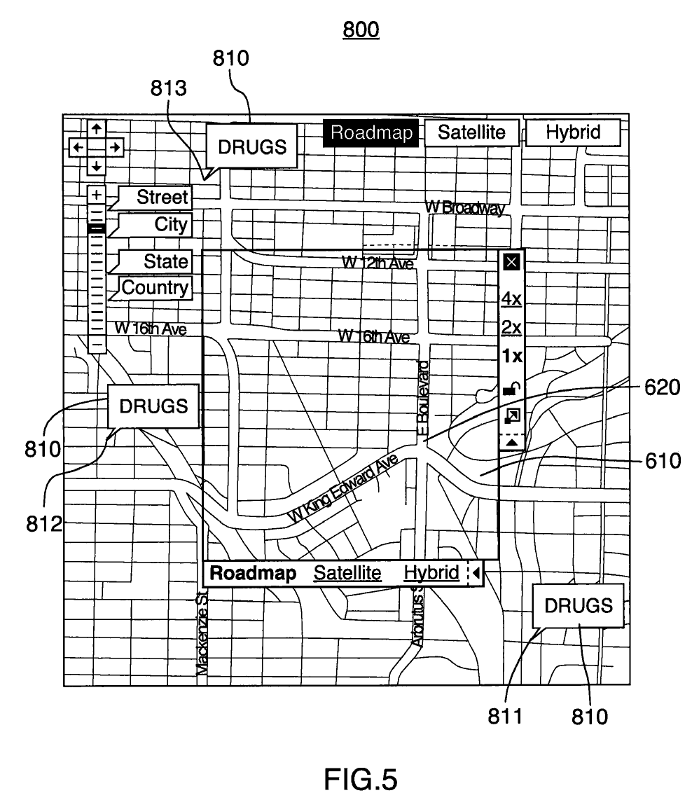

FIG. 5 is a screen capture illustrating a third advertisement presentation 800 in accordance with an embodiment of the invention. FIG. 5 illustrates the effect of selecting the “Show all business locations for the advertiser” option from the dropdown menu associated with FIG. 4 described above. Upon selecting this option, a geo-located advertisement 810 is presented at each business location 811, 812, 813.

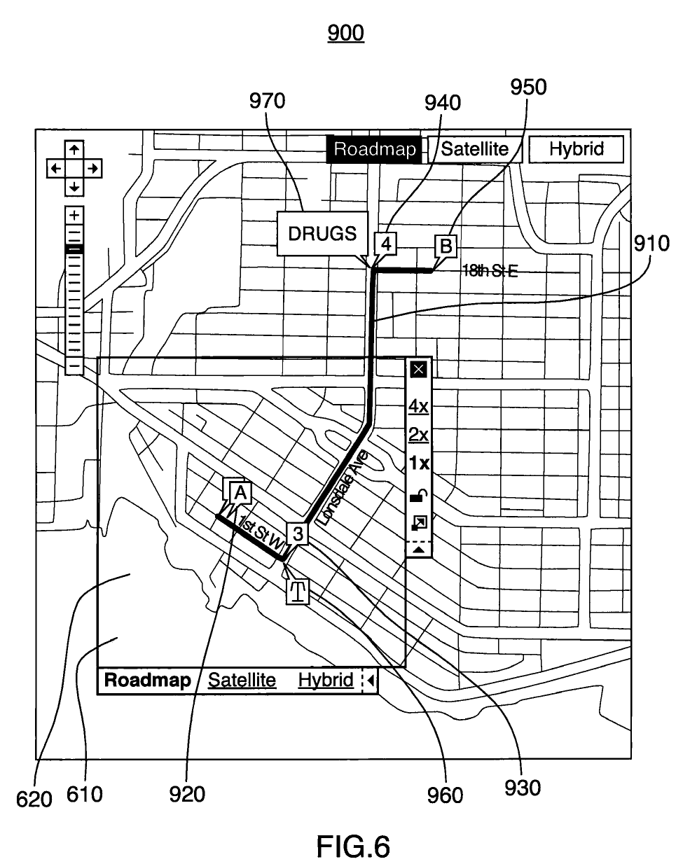

FIG. 6 is a screen capture illustrating a fourth advertisement presentation 900 in accordance with an embodiment of the invention. Users frequently use online maps sites such as Mapquest™ to get directions from one location to another. According to one embodiment, advertisements are combined with direction results for presentation such that advertisements appear at key locations along a route and are presented as landmarks to help the user along the route. FIG. 6 shows a route 910 with landmarks “A” 920, “3” 930, “4” 940, “B” 950 presented along the way. In FIG. 6, advertisements 960, 970 appear as separate interactive (e.g., clickable, draggable, find more, etc.) entities or icons located adjacent to corresponding landmarks or direction markers 930, 940.

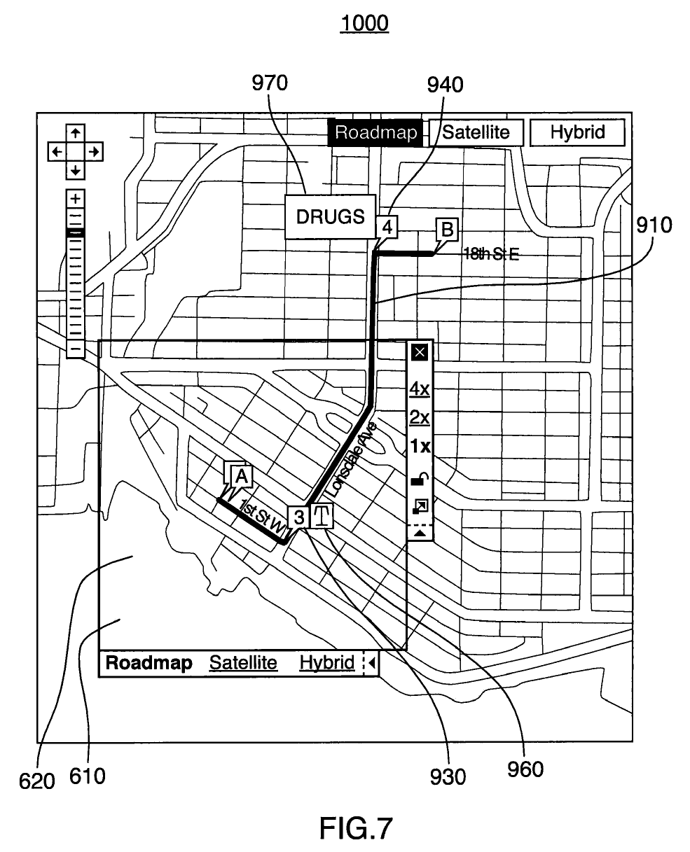

FIG. 7 is a screen capture illustrating a fifth advertisement presentation 1000 in accordance with an embodiment of the invention. In FIG. 6, the advertisements 960, 970 are incorporated in or form part of corresponding direction markers 930, 940.

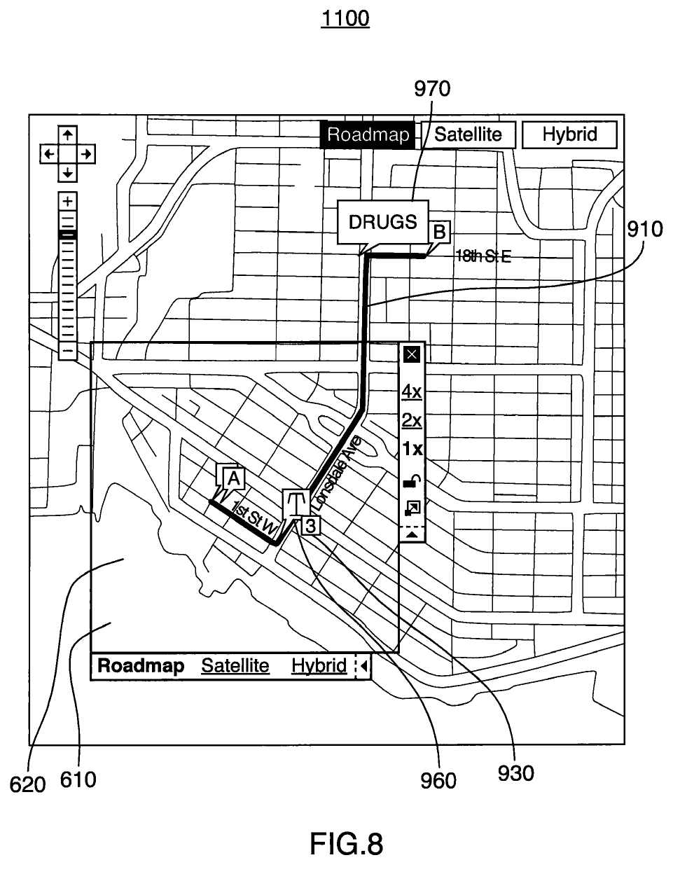

FIG. 8 is a screen capture illustrating a sixth advertisement presentation 1100 in accordance with an embodiment of the invention. As shown in FIG. 8, advertisements 970 may replace corresponding direction markers 940 or advertisements 960 may have marker numbers 930 appearing directly within the advertisement. In FIG. 8, a first advertisement 970 has replaced the direction maker labelled “4” 940 in FIG. 7 while a second advertisement 960 has a “3” in it corresponding to the direction maker labelled “3” 930 in FIG. 7.

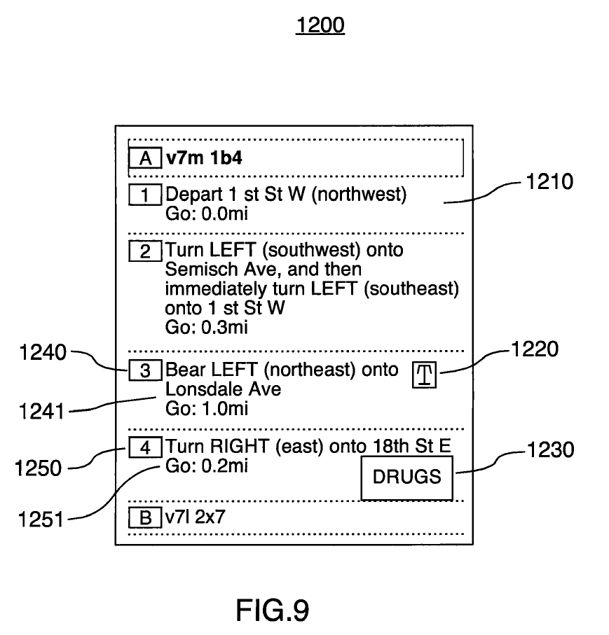

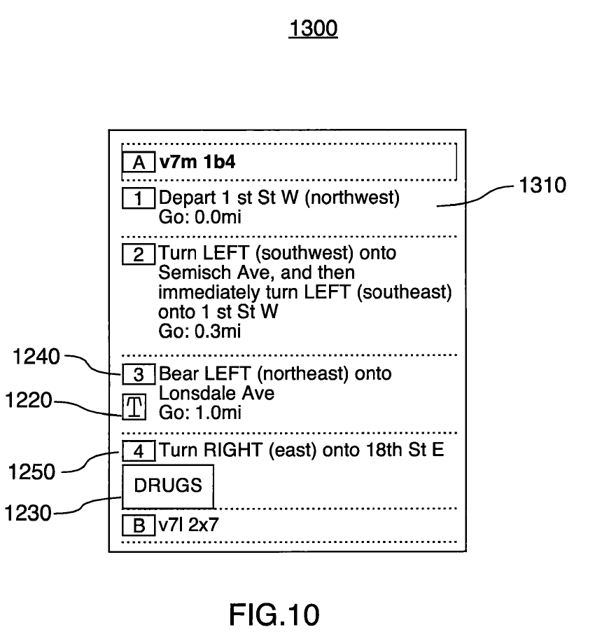

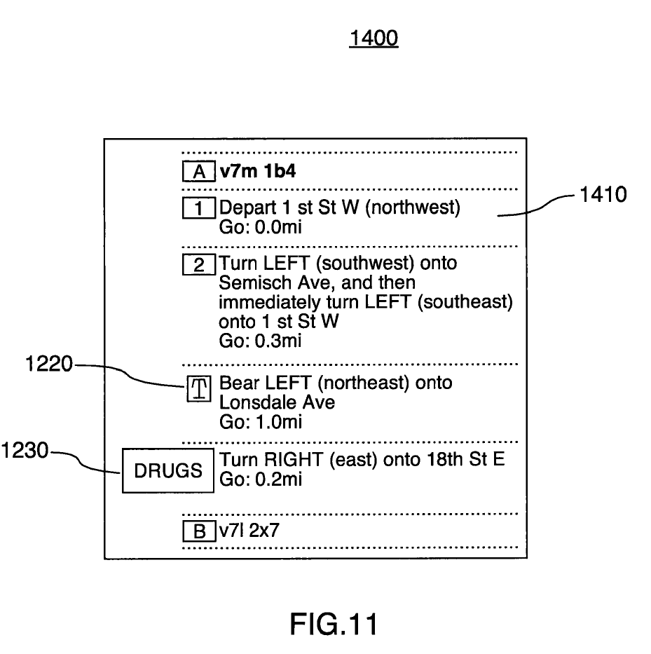

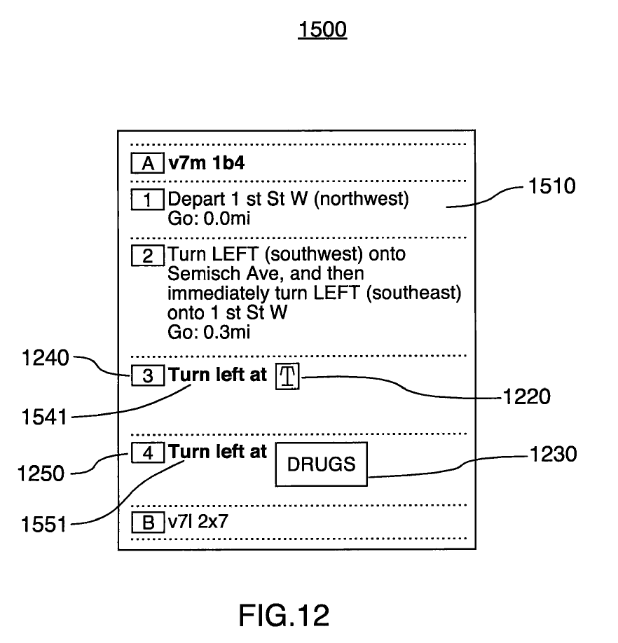

FIGS. 9-12 are screen captures illustrating seventh through tenth advertisement presentations 1200-1500 in accordance with embodiments of the invention. Referring to FIGS. 6-8, the associated text based directions may be integrated with landmark-based advertisements. FIGS. 9-12 are graphical examples showing some of the possible placements of advertisements relative to individual directions steps. In FIG. 9, advertisements 1220, 1230 are presented in the list of directions 1210 to the right of their corresponding direction markers 1240, 1250 and direction texts 1241, 1251. In FIG. 10, advertisements 1220, 1230 are presented in the list of directions 1310 below their corresponding direction markers 1240, 1250. In FIG. 11, advertisements 1220, 1230 are presented in the place of their corresponding direction markers (i.e., 1240, 1250 as shown in FIG. 10) in the list of directions 1410. And, in FIG. 12, advertisements 1220, 1230 are presented as part of or incorporated into their corresponding direction texts 1541, 1551 to the right of their corresponding direction markers 1240, 1250.

Use of Detail-In-Context Lenses. According to one embodiment, a detail-in-context lens 410 may be used rather than the inset magnifier 610 shown in FIGS. 3-8. The term “detail-in-context” refers to the magnification of a particular region-of-interest (the “detail”) in an original image while preserving visibility of the surrounding information (the “context”). A presentation including a detail-in-context lens may be referred to as a detail-in-context presentation. In general, a detail-in-context presentation may be considered as a distorted view of a portion of an original image where the distortion is the result of the application of a “lens” like distortion function to the original image. Detail-in-context presentations may be generated using a variety of the methods. A detailed review of various detail-in-context presentation methods may be found in a publication by Marianne S. T. Carpendale, entitled “A Framework for Elastic Presentation Space” (Carpendale, Marianne S. T., A Framework for Elastic Presentation Space (Burnaby, British Columbia: Simon Fraser University, 1999)), and incorporated herein by reference. Reference may also be made to U.S. Pat. Nos. 7,197,719 and 7,213,214, which are incorporated herein by reference.

According to one embodiment, a detail-in-context presentation may be generated as follows. First, the undistorted original image is located in a base plane of a three-dimensional perspective viewing volume or frustum. A viewpoint is typically located above a centre point of a view plane which is located above the base plane. Points of the original image in the base plane are displaced upward onto a distorted surface or lens which is defined by a three-dimensional distortion function (e.g., the lens may have a truncated pyramid shape having a flat rectangular top surrounded by four inclined trapezoidal sides). The displaced points are then perspectively projected onto the view plane to generate the presentation. The direction of the projection may be in the direction of a line constructed through a point in the base plane through a point in the focal region of the lens. The projection may be in a direction that is viewer-aligned (i.e., the point in the base plane, the point in the focal region, and the viewpoint are collinear). The resultant combination of magnification and compression of the original image as seen in the view plane from the viewpoint results in a lens-like effect similar to that of a magnifying glass applied to the original image. In general, the lens has a “focal region” (e.g., the flat rectangular top of a lens having a truncated pyramid shape) for the region-of-interest. The focal region has an elevation (or magnification) that produces a corresponding “magnified region” for the region-of-interest upon projection onto the view plane. At least partially surrounding the focal region is a “shoulder region” (e.g., the four inclined trapezoidal sides of a lens having a truncated pyramid shape) where the elevation (or magnification) decreases from that of the focal region to that of the original image surrounding the shoulder region and which produces a corresponding at least partially “compressed region” upon projection onto the view plane.

FIG. 13 is a partial screen capture illustrating a GUI 400 having lens control elements for adjusting detail-in-context presentations in accordance with an embodiment of the invention. The lens control elements of the GUI 400 are adjusted by the user via an input device 310 to control the characteristics of the lens 410 (shown after projection in FIG. 13) used to generate the detail-in-context presentation. Using the input device 310 (e.g., a mouse), a user adjusts parameters of the lens 410 using icons and scroll bars of the GUI 400 that are displayed over the magnified and compressed regions 420, 430 on the display screen 340. Signals representing input device 310 movements and selections are transmitted to the CPU 320 of the data processing system 300 where they are translated into instructions for lens control.

The lens 410 (shown after projection in FIG. 13) includes a focal region 420 (shown after projection in FIG. 13) which produces a magnified region 420 after projection at least partially surrounded by a shoulder region 430 (shown after projection in FIG. 13) which produces an at least partially compressed region 430 after projection. In FIG. 4, the lens 410 is shown with a rectangular shaped focal region 420 lying near the center of the lens 410 and with a circular shaped shoulder region 430 surrounding the focal region 420. However, the lens 410 and its focal and shoulder regions 420, 430 may have any desired shape (e.g., square, rectangular, circular, etc.).

The GUI 400 may include the following lens control elements: move, pickup, resize shoulder region, resize focal region, fold, magnify, zoom, and scoop. Each of these lens control elements may have at least one lens control icon or alternate cursor icon associated with it. In general, when a lens 410 is selected by a user through a point and click operation, the following lens control icons may be displayed over the lens 410: pickup icon 450, lens outline icon 412, shoulder region bounding rectangle icon 411, focal region bounding rectangle icon 421, handle icons 481, 482, 491, magnify slide bar icon 440, zoom icon 495, and scoop slide bar icon (not shown). Typically, these icons are displayed simultaneously after selection of the lens 410. In addition, when the cursor 401 is located within the extent of a selected lens 410, an alternate cursor icon 460, 470, 480, 490, 495 may be displayed over the lens 410 to replace the cursor 401 or may be displayed in combination with the cursor 401. These lens control elements, corresponding icons, and their effects on the characteristics of a lens 410 are described below with reference to FIG. 13.

In general, when a lens 410 is selected by a point and click operation, bounding rectangle icons 411, 421 are displayed surrounding the focal region 420 and shoulder region 430 of the selected lens 410 to indicate that the lens 410 has been selected. With respect to the bounding rectangles 411, 421 one might view them as glass windows enclosing the focal region 420 and the shoulder region 430, respectively. The bounding rectangles 411, 421 include handle icons 481, 482, 491 allowing for direct manipulation of the focal region 420 and the shoulder region 430 as will be explained below. Thus, the bounding rectangles 411, 421 not only inform the user that the lens 410 has been selected, but also provide the user with indications as to what manipulation operations might be possible for the selected lens 410 though use of the displayed handles 481, 482, 491. Note that the bounding rectangle 411, 421 may be of any shape.

Moreover, the cursor 401 provides a visual cue indicating the nature of an available lens control element. As such, the cursor 401 will generally change in form by simply pointing to a different lens control icon 450, 412, 411, 421, 481, 482, 491, 440. For example, when resizing the shoulder region 430 of a lens 410 using a corner handle 491, the cursor 401 may change form to a resize icon 490 once it is pointed at (i.e., positioned over) the corner handle 491. The cursor 401 may remain in the form of the resize icon 490 until the cursor 401 has been moved away from the corner handle 491.

Lateral movement of a lens 410 is provided by the move lens control element of the GUI 400. This functionality is accomplished by the user first selecting the lens 410 through a point and click operation. Then, the user points to a point within the lens 410 that is other than a point lying on a lens control icon 450, 412, 411, 421, 481, 482, 491, 440. When the cursor 401 is so located, a move icon 460 is displayed over the lens 410 to replace the cursor 401 or may be displayed in combination with the cursor 401. The move icon 460 not only informs the user that the lens 410 may be moved, but also provides the user with indications as to what movement operations are possible for the selected lens 410. For example, the move icon 460 may include arrowheads indicating up, down, left, and right motion. Next, the lens 410 is moved by a click and drag operation in which the user clicks and drags the lens 410 to the desired position on the screen 340 and then releases the mouse button 310. The lens 410 is locked in its new position until a further pickup and move operation is performed.

Lateral movement of a lens 410 is also provided by the pickup lens control element of the GUI 400. This functionality is accomplished by the user first selecting the lens 410 through a point and click operation. As mentioned above, when the lens 410 is selected a pickup icon 450 is displayed over the lens 410 near the centre of the lens 410. Typically, the pickup icon 450 will be a crosshairs. In addition, a lens outline icon 412 is displayed over the lens 410 representing the perimeter of the lens 410 (i.e., the perimeter of the shoulder region 430). The crosshairs 450 and lens outline 412 not only inform the user that the lens has been selected, but also provides the user with an indication as to the pickup operation that is possible for the selected lens 410. Next, the user points at the crosshairs 450 with the cursor 401. Then, the lens outline 412 is moved by a click and drag operation in which the user clicks and drags the crosshairs 450 to the desired position on the screen 340 and then releases the mouse button 310. The full lens 410 is then moved to the new position and is locked there until a further pickup operation is performed. In contrast to the move operation described above, with the pickup operation, it is the lens outline 412 that the user repositions rather than the full lens 410.

Resizing of the shoulder region 430 of a lens 410 is provided by the resize shoulder region lens control element of the GUI. After the lens 410 is selected, a bounding rectangle icon 411 is displayed surrounding the shoulder region 430. For a rectangular shaped shoulder region 430, the bounding rectangle icon 411 may be coextensive with the perimeter of the shoulder region 430. The bounding rectangle 411 includes handles 491. These handles 491 can be used to stretch the shoulder region 430 taller or shorter, wider or narrower, or proportionally larger or smaller. The corner handles 491 will keep the proportions the same while changing the size. The middle handles (not shown) will make the shoulder region 430 taller or shorter, wider or narrower. Resizing the shoulder region 430 by the corner handles 491 will keep the shoulder region 430 in proportion. Resizing the shoulder region 430 by the middle handles will change the proportions of the shoulder region 430. That is, the middle handles change the aspect ratio of the shoulder region 430 (i.e., the ratio between the height and the width of the bounding rectangle 411 of the shoulder region 430). When a user points at a handle 491 with the cursor 401 a resize icon 490 may be displayed over the handle 491 to replace the cursor 401 or may be displayed in combination with the cursor 401. The resize icon 490 not only informs the user that the handle 491 may be selected, but also provides the user with indications as to the resizing operations that are possible with the selected handle. For example, the resize icon 490 for a corner handle 491 may include arrows indicating proportional resizing. The resize icon (not shown) for a middle handle may include arrows indicating width resizing or height resizing. After pointing at the desired handle 491 the user would click and drag the handle 491 until the desired shape and size for the shoulder region 430 is reached. Once the desired shape and size are reached, the user would release the mouse button 310. The shoulder region 430 of the lens 410 is then locked in its new size and shape until a further resize shoulder region operation is performed.

Resizing of the focal region 420 of a lens 410 is provided by the resize focal region lens control element of the GUI. After the lens 410 is selected, a bounding rectangle icon 421 is displayed surrounding the focal region 420. For a rectangular shaped focal region 420, the bounding rectangle icon 421 may be coextensive with the perimeter of the focal region 420. The bounding rectangle 421 includes handles 481, 482. These handles 481, 482 can be used to stretch the focal region 420 taller or shorter, wider or narrower, or proportionally larger or smaller. The corner handles 481 will keep the proportions the same while changing the size. The middle handles 482 will make the focal region 420 taller or shorter, wider or narrower. Resizing the focal region 420 by the corner handles 481 will keep the focal region 420 in proportion. Resizing the focal region 420 by the middle handles 482 will change the proportions of the focal region 420. That is, the middle handles 482 change the aspect ratio of the focal region 420 (i.e., the ratio between the height and the width of the bounding rectangle 421 of the focal region 420). When a user points at a handle 481, 482 with the cursor 401 a resize icon 480 may be displayed over the handle 481, 482 to replace the cursor 401 or may be displayed in combination with the cursor 401. The resize icon 480 not only informs the user that a handle 481, 482 may be selected, but also provides the user with indications as to the resizing operations that are possible with the selected handle. For example, the resize icon 480 for a corner handle 481 may include arrows indicating proportional resizing. The resize icon 480 for a middle handle 482 may include arrows indicating width resizing or height resizing. After pointing at the desired handle 481, 482, the user would click and drag the handle 481, 482 until the desired shape and size for the focal region 420 is reached. Once the desired shape and size are reached, the user would release the mouse button 310. The focal region 420 is then locked in its new size and shape until a further focus resize operation is performed.

Folding of the focal region 420 of a lens 410 is provided by the fold control element of the GUI. In general, control of the degree and direction of folding is accomplished by a click and drag operation on a point 471, other than a handle 481, 482, on the bounding rectangle 421 surrounding the focal region 420. The direction of folding is determined by the direction in which the point 471 is dragged. The degree of folding is determined by the magnitude of the translation of the cursor 401 during the drag. In general, the direction and degree of folding corresponds to the relative displacement of the focal region 420 with respect to the shoulder region 430. In particular, after the lens 410 is selected, a bounding rectangle icon 421 is displayed surrounding the focal region 420. The bounding rectangle 421 includes handles 481, 482. When a user points at a point 471, other than a handle 481, 482, on the bounding rectangle 421 surrounding the focal region 420 with the cursor 401, a fold icon 470 may be displayed over the point 471 to replace the cursor 401 or may be displayed in combination with the cursor 401. The fold icon 470 not only informs the user that a point 471 on the bounding rectangle 421 may be selected, but also provides the user with indications as to what fold operations are possible. For example, the fold icon 470 may include arrowheads indicating up, down, left, and right motion. By choosing a point 471, other than a handle 481, 482, on the bounding rectangle 421 a user may control the degree and direction of folding. To control the direction of folding, the user would click on the point 471 and drag in the desired direction of folding. To control the degree of folding, the user would drag to a greater or lesser degree in the desired direction of folding. Once the desired direction and degree of folding is reached, the user would release the mouse button 310. The lens 410 is then locked with the selected fold until a further fold operation is performed.

Magnification (i.e., elevation) of the lens 410 is provided by the magnify lens control element of the GUI. After the lens 410 is selected, the magnify control is presented to the user as a slide bar icon 440 near or adjacent to the lens 410 and typically to one side of the lens 410. Sliding the bar 441 of the slide bar 440 results in a proportional change in the magnification of the lens 410. The slide bar 440 not only informs the user that magnification of the lens 410 may be selected, but also provides the user with an indication as to what level of magnification is possible. The slide bar 440 includes a bar 441 that may be slid up and down, or left and right, to adjust and indicate the level of magnification. To control the level of magnification, the user would click on the bar 441 of the slide bar 440 and drag in the direction of desired magnification level. Once the desired level of magnification is reached, the user would release the mouse button 310. The lens 410 is then locked with the selected magnification until a further magnification operation is performed. In general, the focal region 420 is an area of the lens 410 having constant magnification (e.g., for a focal region 420 that is the flat rectangular top of a lens having a truncated pyramid shape). Magnification of the focal region 420 varies inversely with the distance from the focal region 420 to the view plane. Magnification of areas lying in the shoulder region 430 of the lens 410 also varies inversely with their distance from the view plane. Thus, magnification of areas lying in the shoulder region 430 will range from unity at the perimeter (e.g., 412) of the shoulder region 430 to the level of magnification of the focal region 420 (e.g., for a shoulder region 430 that comprises the four inclined trapezoidal sides of a lens having a truncated pyramid shape).

Zoom functionality is provided by the zoom lens control element of the GUI. The zoom lens control element allows a user to quickly navigate to a region-of-interest within an original image and then zoom in to that region-of-interest for detailed viewing or editing. Referring to FIG. 13, the combined presentation area covered by the focal region 420 and shoulder region 430 may be referred to as the “extent of the lens”. Similarly, the presentation area covered by the focal region 420 may be referred to as the “extent of the focal region”. The extent of the lens may be indicated to a user by a shoulder region bounding rectangle 411 when the lens 410 is selected. The extent of the lens may also be indicated by an arbitrarily shaped figure that bounds or is coincident with the perimeter (e.g., 412) of the shoulder region 430. Similarly, the extent of the focal region may be indicated by a focal region bounding rectangle 421 or arbitrarily shaped figure. The zoom lens control element allows a user to: (a) “zoom in” to the extent of the focal region such that the extent of the focal region fills the display screen 340 (i.e., “zoom to focal region extent”); (b) “zoom in” to the extent of the lens such that the extent of the lens fills the display screen 340 (i.e., “zoom to lens extent”); or, (c) “zoom in” to the area lying outside of the extent of the focal region such that the area without the focal region is magnified to the same level as the extent of the focal region (i.e., “zoom to scale”).

In particular, after the lens 410 is selected, a bounding rectangle icon 411 is displayed surrounding the shoulder region 430 and a bounding rectangle icon 421 is displayed surrounding the focal region 420. Zoom functionality is accomplished by the user first selecting the zoom icon 495 through a point and click operation When a user selects zoom functionality, a zoom cursor icon 496 may be displayed to replace the cursor 401 or may be displayed in combination with the cursor 401. The zoom cursor icon 496 provides the user with indications as to what zoom operations are possible. For example, the zoom cursor icon 496 may include a magnifying glass. By choosing a point within the extent of the focal region, within the extent of the lens, or without the extent of the lens, the user may control the zoom function. To zoom in to the extent of the focal region such that the extent of the focal region fills the display screen 340 (i.e., “zoom to focal region extent”), the user would point and click within the extent of the focal region. To zoom in to the extent of the lens such that the extent of the lens fills the display screen 340 (i.e., “zoom to lens extent”), the user would point and click within the extent of the lens. Or, to zoom in to the presentation area without the extent of the focal region, such that the area without the extent of the focal region is magnified to the same level as the extent of the focal region (i.e., “zoom to scale”), the user would point and click without the extent of the lens. After the point and click operation is complete, the presentation is locked with the selected zoom until a further zoom operation is performed.

Alternatively, rather than choosing a point within the extent of the focal region, within the extent of the lens, or without the extent of the lens to select the zoom function, a zoom function menu with multiple items (not shown) or multiple zoom function icons (not shown) may be used for zoom function selection. The zoom function menu may be presented as a pull-down menu. The zoom function icons may be presented in a toolbar or adjacent to the lens 410 when the lens is selected. Individual zoom function menu items or zoom function icons may be provided for each of the “zoom to focal region extent”, “zoom to lens extent”, and “zoom to scale” functions described above. In this alternative, after the lens 410 is selected, a bounding rectangle icon 411 may be displayed surrounding the shoulder region 430 and a bounding rectangle icon 421 may be displayed surrounding the focal region 420. Zoom functionality is accomplished by the user selecting a zoom function from the zoom function menu or via the zoom function icons using a point and click operation. In this way, a zoom function may be selected without considering the position of the cursor 401 within the lens 410.

The concavity or “scoop” of the shoulder region 430 of the lens 410 is provided by the scoop lens control element of the GUI. After the lens 410 is selected, the scoop control is presented to the user as a slide bar icon (not shown) near or adjacent to the lens 410 and typically below the lens 410. Sliding the bar (not shown) of the slide bar results in a proportional change in the concavity or scoop of the shoulder region 430 of the lens 410. The slide bar not only informs the user that the shape of the shoulder region 430 of the lens 410 may be selected, but also provides the user with an indication as to what degree of shaping is possible. The slide bar includes a bar that may be slid left and right, or up and down, to adjust and indicate the degree of scooping. To control the degree of scooping, the user would click on the bar of the slide bar and drag in the direction of desired scooping degree. Once the desired degree of scooping is reached, the user would release the mouse button 310. The lens 410 is then locked with the selected scoop until a further scooping operation is performed.

Advantageously, a user may choose to hide one or more lens control icons 450, 412, 411, 421, 481, 482, 491, 440, 495 shown in FIG. 13 from view so as not to impede the user's view of the image within the lens 410. This may be helpful, for example, during an editing or move operation. A user may select this option through means such as a menu, toolbar, or lens property dialog box.

In addition, the GUI 400 maintains a record of control element operations such that the user may restore pre-operation presentations. This record of operations may be accessed by or presented to the user through “Undo” and “Redo” icons 497, 498, through a pull-down operation history menu (not shown), or through a toolbar.

For example, in order to view a selected region-of-interest in detail, a user can define a lens 410 over the region-of-interest using the GUI 400. The lens 410 may be introduced to the original image to form the a presentation through the use of a pull-down menu selection, tool bar icon, etc. Using lens control elements for the GUI 400, such as move, pickup, resize base, resize focus, fold, magnify, zoom, and scoop, as described above, the user adjusts the lens 410 for detailed viewing of the region-of-interest. Using the magnify lens control element, for example, the user may magnify the focal region 420 of the lens 410 to pixel quality resolution revealing detailed information pertaining to the selected region-of-interest. That is, the portion of the original image outside the extent of the lens is displayed at a low resolution while the portion of the original image within the extent of the lens is displayed at a resolution based on a user selected magnification 440, 441.

Moreover, the lens 410 may be added to the presentation before or after the region-of-interest is selected. That is, the user may first add a lens 410 to a presentation or the user may move a pre-existing lens into place over the selected region-of-interest. The lens 410 may be introduced to the original image to form the presentation through the use of a pull-down menu selection, tool bar icon, etc.

Advantageously, by using a detail-in-context lens 410, a user can view a large area (i.e., outside the extent of the lens 410) while focusing in on a smaller area (i.e., within the focal region 420 of the lens 410) including and/or surrounding the selected region-of-interest. This makes it possible for a user to view the region-of-interest in detail without losing visibility or context of the portion of the original image surrounding the region-of-interest.

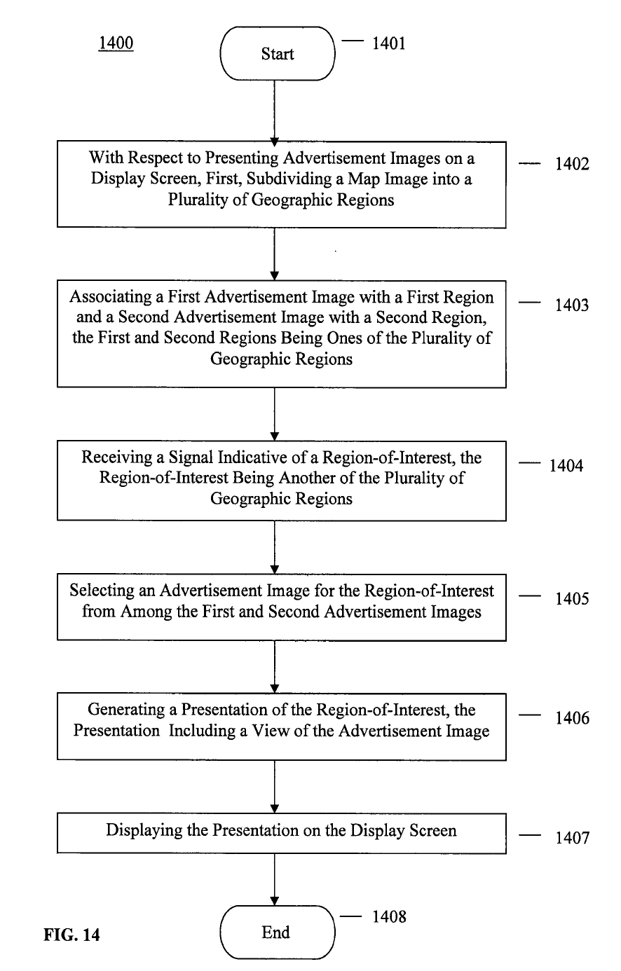

Aspects of the above described method may be summarized with the aid of a flowchart. FIG. 14 is a flow chart illustrating operations 1400 of modules 321, 331 within a data processing system 300 for presenting advertisement images on a display screen 340, in accordance with an embodiment of the invention.

At step 1401, the operations 1400 start.

At step 1402, a map image 530 is subdivided into a plurality of geographic regions 520, 521, 522.

At step 1403, a first advertisement image (e.g., 510) is associated with a first region 520 and a second advertisement image (e.g., 510) is associated with a second region 521, the first and second regions 520, 521 being ones of the plurality of geographic regions.

At step 1404, a signal indicative of a region-of-interest 522 is received, the region-of-interest 522 being another of the plurality of geographic regions 520, 521, 522.

At step 1405, an advertisement image (e.g., 510) for the region-of-interest 522 is selected from among the first and second advertisement images.

At step 1406, a presentation 500 of the region-of-interest is generated, the presentation 500 including a view (e.g., 540) of the advertisement image 510.

At step 1407, the presentation 500 is displayed on the display screen 340.

At step 1408, the operations 1400 end.

In the above method, the selecting 1405 may include comparing a first distance between the region-of-interest 522 and the first region 520 to a second distance between the region-of-interest 522 and the second region 521. The selecting 1405 may further include receiving a signal indicative of an input and comparing the input to one or more respective features of the first and second regions 520, 521. The input may be is a browsing history. The input may be user selected. The input may be a location of a user. The selecting 1405 may include comparing a first price associated with the first advertisement image to a second price associated with the second advertisement image. The selecting 1405 may include comparing a first scale associated with the first advertisement image to a second scale associated with the second advertisement image. The selecting 1405 may include comparing a first distance between a feature in the map image 530 and the first region 520 to a second distance between the feature in the map image 530 and the second region 521. The feature in the map image may be a road. The feature in the map image 530 may be a landmark. The first and second advertisement images may be further associated with first and second groups of regions of the plurality of geographic regions, respectively, and the selecting 1405 may include determining whether the region-of-interest 522 belongs to one of the first and second groups of regions. The selecting 1405 may include comparing a first distance between a location of a user and the first region 520 to a second distance between the location of the user and the second region 521. And, the first and second regions 520, 521 may be a plurality of regions 520, 521, 561 and the first and second advertisement images may be a respective plurality of advertisement images 510.

While this invention is primarily discussed as a method, a person of ordinary skill in the art will understand that the apparatus discussed above with reference to a data processing system 300, may be programmed to enable the practice of the method of the invention. Moreover, an article of manufacture for use with a data processing system 300, such as a pre-recorded storage device or other similar computer readable medium including program instructions recorded thereon, may direct the data processing system 300 to facilitate the practice of the method of the invention. It is understood that such apparatus and articles of manufacture also come within the scope of the invention.

In particular, the sequences of instructions which when executed cause the method described herein to be performed by the data processing system 300 can be contained in a data carrier product according to one embodiment of the invention. This data carrier product can be loaded into and run by the data processing system 300. In addition, the sequences of instructions which when executed cause the method described herein to be performed by the data processing system 300 can be contained in a computer software product according to one embodiment of the invention. This computer software product can be loaded into and run by the data processing system 300. Moreover, the sequences of instructions which when executed cause the method described herein to be performed by the data processing system 300 can be contained in an integrated circuit product (e.g., a hardware module or modules 321) which may include a coprocessor or memory according to one embodiment of the invention. This integrated circuit product can be installed in the data processing system 300.

The embodiments of the invention described above are intended to be exemplary only. Those skilled in the art will understand that various modifications of detail may be made to these embodiments, all of which come within the scope of the invention.

What is claimed is:

1. A method for presenting advertisement images on a display screen, comprising:
subdividing a map image into a plurality of geographic regions;
associating a first advertisement image with a first region and a second advertisement image with a second region, the first and second regions being ones of the plurality of geographic regions;
receiving a signal indicative of a region-of-interest, the region-of-interest being another of the plurality of geographic regions;
selecting an advertisement image for the region-of-interest from among the first and second advertisement images;
generating a presentation of the region-of-interest, the presentation including a view of the advertisement image; and,
displaying the presentation on the display screen.

2. The method of claim 1 wherein the selecting includes comparing a first distance between the region-of-interest and the first region to a second distance between the region-of-interest and the second region.

3. The method of claim 1 wherein the selecting further comprises receiving a signal indicative of an input and comparing the input to one or more respective features of the first and second regions.

4. The method of claim 3 wherein the input is a browsing history.

5. The method of claim 3 wherein the input is user selected.

6. The method of claim 3 wherein the input is a location of a user.

7. The method of claim 1 wherein the selecting includes comparing a first price associated with the first advertisement image to a second price associated with the second advertisement image.

8. The method of claim 1 wherein the selecting includes comparing a first scale associated with the first advertisement image to a second scale associated with the second advertisement image.

9. The method of claim 1 wherein the selecting includes comparing a first distance between a feature in the map image and the first region to a second distance between the feature in the map image and the second region.

10. The method of claim 9 wherein the feature in the map image is a road.

11. The method of claim 9 wherein the feature in the map image is a landmark.

12. The method of claim 1 wherein the first and second advertisement images are further associated with first and second groups of regions of the plurality of geographic regions, respectively, and wherein the selecting includes determining whether the region-of-interest belongs to one of the first and second groups of regions.

13. The method of claim 1 wherein the selecting includes comparing a first distance between a location of a user and the first region to a second distance between the location of the user and the second region.

14. A method for presenting advertisement images on a display screen, comprising:
subdividing a map image into a plurality of geographic regions;
associating first and second advertisement images with a region within the plurality of geographic regions, the first advertisement image being associated with a first category of advertisement images and the second advertisement image being associated with a second category of advertisement images;
receiving a signal indicative of a region-of-interest, the region-of-interest corresponding to the region;
selecting an advertisement image for the region-of-interest from among the first and second advertisement images;
generating a presentation of the region-of-interest, the presentation including a view of the advertisement image; and,
displaying the presentation on the display screen.

15. The method of claim 14 wherein the selecting further comprises receiving a signal indicative of an input and comparing the input to one or more respective features of the first and second categories of advertisement images.

16. The method of claim 15 wherein the input is an indication of a category of advertisement images.

17. The method of claim 15 wherein the input is a browsing history.

18. The method of claim 14 wherein the first and second categories of advertisement images are associated with first and second business classifications, respectively.

19. A method for presenting advertisement images on a display screen, comprising:
subdividing a map image into a plurality of geographic regions;
associating an advertisement image with a location within a region of the plurality of geographic regions;
receiving a signal indicative of a region-of-interest, the region-of-interest corresponding to the region;
generating a presentation of the region-of-interest, the presentation including the advertisement image; and,
displaying the presentation on the display screen.

20. The method of claim 19 wherein the advertisement image is positioned at the location within the presentation.

21. The method of claim 19 wherein the advertisement image is an icon.

22. The method of claim 19 wherein the advertisement image is indicative of a business.

23. The method of claim 19 wherein the advertisement image is positioned other than at the location within the presentation.

24. The method of claim 23 and further comprising:
receiving a signal indicative of a selection of the advertisement image;
generating a new presentation of the region-of-interest wherein the new presentation includes the advertisement image positioned at the location; and,
displaying the new presentation on the display screen to replace display of the presentation.

25. The method of claim 19 and further comprising:
receiving a signal indicative of a route, the location being proximate to a point along the route; and,
including a representation of the route in the presentation.

26. The method of claim 25 wherein the representation includes a direction marker for the point.

27. The method of claim 26 wherein the direction marker is a direction marker icon.

28. The method of claim 26 wherein the direction marker includes the advertisement image.

29. The method of claim 26 wherein the direction marker and the advertisement image are combined.

30. The method of claim 26 wherein the direction marker is the advertisement image.

31. The method of claim 19 and further comprising:
receiving a signal indicative of a route, the location being proximate to a point along the route; and,
including direction text for the point in the presentation.

32. The method of claim 31 wherein the direction text includes direction information or instructions associated with the point.

33. The method of claim 32 wherein the direction text begins with a direction marker for the point.

34. The method of claim 33 wherein the direction marker is a direction marker icon.

35. The method of claim 33 wherein the advertisement image is positioned at a side of the direction text.

36. The method of claim 33 wherein the advertisement image is positioned adjacent to the direction marker in the direction text.

37. The method of claim 33 wherein the direction marker is the advertisement image.

38. The method of claim 33 wherein the direction text includes the advertisement image.

39. A method for presenting advertisement images on a display screen, comprising:
subdividing a map image into a plurality of geographic regions;
receiving a signal indicative of a first region of the plurality of geographic regions;
sending a signal indicative of the first region to a server, the server associating a first advertisement image with the first region;
receiving the first advertisement image from the server;
generating a first presentation of the first region, the first presentation including the first advertisement image; and,
displaying the first presentation on the display screen.

40. The method of claim 39 wherein the server associates a second advertisement image with a second region of the plurality of geographic regions, the second region being proximate the first region, and further comprising receiving the second advertisement image from the server with the first advertisement image.

41. The method of claim 40 and further comprising:
receiving a signal indicative of the second region;
generating a second presentation of the second region, the second presentation including the second advertisement image; and,
displaying the second presentation on the display screen to replace display of the first presentation.

42. The method of claim 39 and further comprising:
receiving a signal indicative of a second region of the plurality of geographic regions;
sending a signal indicative of the second region to the server, the server associating a second advertisement image with the second region;
receiving the second advertisement image from the server;
generating a second presentation of the second region, the second presentation including the second advertisement image; and,
displaying the second presentation on the display screen to replace display of the first presentation.

43. The method of claim 42 and further comprising determining whether a distance between the first and second regions exceeds a threshold.

44. The method of claim 43 wherein the sending of the signal indicative of the second region to the server only occurs if the threshold is exceeded.

45. The method of claim 42 and further comprising determining whether a boundary separating the first and second regions exists.

46. The method of claim 45 wherein the sending of the signal indicative of the second region to the server only occurs if the boundary exists.

47. The method of claim 42 and further comprising determining whether a time interval between the sending of the signal indicative of the first region to the server and the sending of the signal indicative of the second region to the server exceeds a threshold.

48. The method of claim 47 wherein the sending of the signal indicative of the second region to the server only occurs if the threshold is exceeded.

49. The method of claim 39 wherein the signal indicative of the first region includes a scale, the server associating a first advertisement image with the first region and the scale.

50. The method of claim 42 wherein the signal indicative of the second region includes a scale, the server associating a second advertisement image with the second region and the scale.

51. The method of claim 1 wherein the first and second regions are a plurality of regions and the first and second advertisement images are a respective plurality of advertisement images.
